(19) United States
(12) Patent Application Publication
(10) Pub. No.: US 2004/0242287 A1
(43) Pub. Date: Dec. 2, 2004

(54) Cell phone design

(76) Inventor: Robert T. Eigelberger, Palm Beach, FL (US)

Correspondence Address: AKERMAN SENTERFITT, P.O. BOX 3188, WEST PALM BEACH, FL, 33402-3188, US

(21) Appl. No.: 10/445,405

(22) Filed: May 27, 2003

(51) Int. Cl. H04B 1/38; H04M 1/00

(52) U.S. Cl. 455/575.1; 455/566

(57) ABSTRACT

A wireless device for operation by one-hand having operational elements including a viewing screen and a numeric keyboard where the viewing screen is positioned below the numeric keyboard. The wireless device can have keyboard and a viewing screen where the viewing screen is located below the keyboard. Additionally, a wireless device having all operational elements including a keyboard and a viewing screen where the viewing screen is positioned lower on the wireless device than the keyboard, with the keyboard being positioned above the viewing screen.

### BACKGROUND OF THE INVENTION

Cell phones have been rising in popularity over the last several decades, a time which they have become more efficient and progressively smaller. Over this time, the basic cell phone has changed little in appearance with respect to placement of earpiece microphone, antenna, viewing screen, and numerical keyboard.

As the cell phones have increased in compactness, gradually use by many cell phone owners has progressed from two-hand to single-hand usage. For example, although not condoned, many drivers use their phone by dialing with one hand, while steering a motor vehicle with the other. Likewise, cell phones are used while eating, playing with children, using a computer, bike riding, and in numerous other activities.

In years past, the typical cell phone user would hold the phone in one hand and engage the keyboard with fingers of his other hand. Improved compactness now enables a cell phone user to hold the phone in one hand and operate the keyboard with the same hand, typically using one's thumb. With such customary use, the placement of the keyboard toward the bottom of the device creates problems for many users, as the phone must be gripped towards its base and considerable effort expended to engage the number buttons, particularly the keys at the lowest row, which would normally be the zero, asterisk, and pound keys. Any position which is awkward may also be dangerous if the concentration of the user is diverted when the phone is being used in conjunction with other activities such as walking or driving, or trying to use the device at night or in substandard lighting.

### SUMMARY OF THE INVENTION

It is an object of the subject invention to provide a cell phone which can be operated more easily than previously, particularly with one hand. It is a further object of the subject invention to provide a cell phone with placement of the elements positioned to better accommodate the physical strength, flexibility, and coordination of the user. Another object of the present invention is to create a new design cell phone which is safer to use and which can be operated with greater efficiency by the user.

In accordance with the above objects, the new cell phone design calls for the positioning of the keyboard toward the top of the cell phone, with the positioning of the screen being below the keyboard and toward the bottom of the unit. With such a new design, the user has much better control over his use of the keyboard. As the cell phone rests within the palm of the hand, the thumb can readily reach all keys, as the thumb generally assumes its normal position of alignment in the general direction of the other fingers.

Instead of having to severely bend the thumb to reach the bottom rows of the keyboard, the thumb comfortably extends to all rows of the keyboard when the keyboard is positioned toward the upper portion of the cell phone. The placement of the screen below the keyboard has no negative impact, as it can be viewed just as easily, whether positioned at the upper or lower portion of the cell phone.

In some phone models, operational keys are positioned right below the screen. The problem with this positioning is that during their use, when the thumb is bent, the first knuckle joint will extend upwardly and in front of the screen, interfering with the viewing thereof. Such interference is totally eliminated, with the screen being placed below the keyboard, as the upward crooking of the thumb is substantially above the new placement of the viewing screen in the lower area of the cell phone.

### DETAILED DESCRIPTION OF THE DRAWINGS

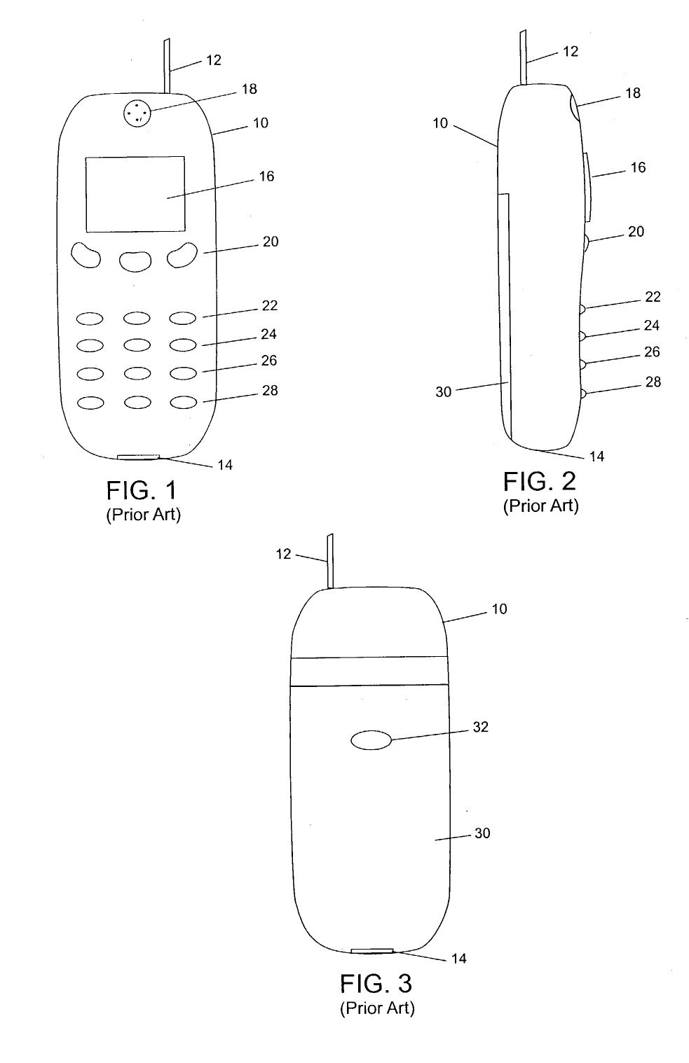

FIG. 1 shows a front elevational view of a standard type cell phone, which is identified as typical prior art.

FIG. 2 shows the side view of the cell phone of FIG. 1.

FIG. 3 shows a rear view of the cell phone of FIG. 1.

FIG. 4 is a front elevational view of the new cell phone design.

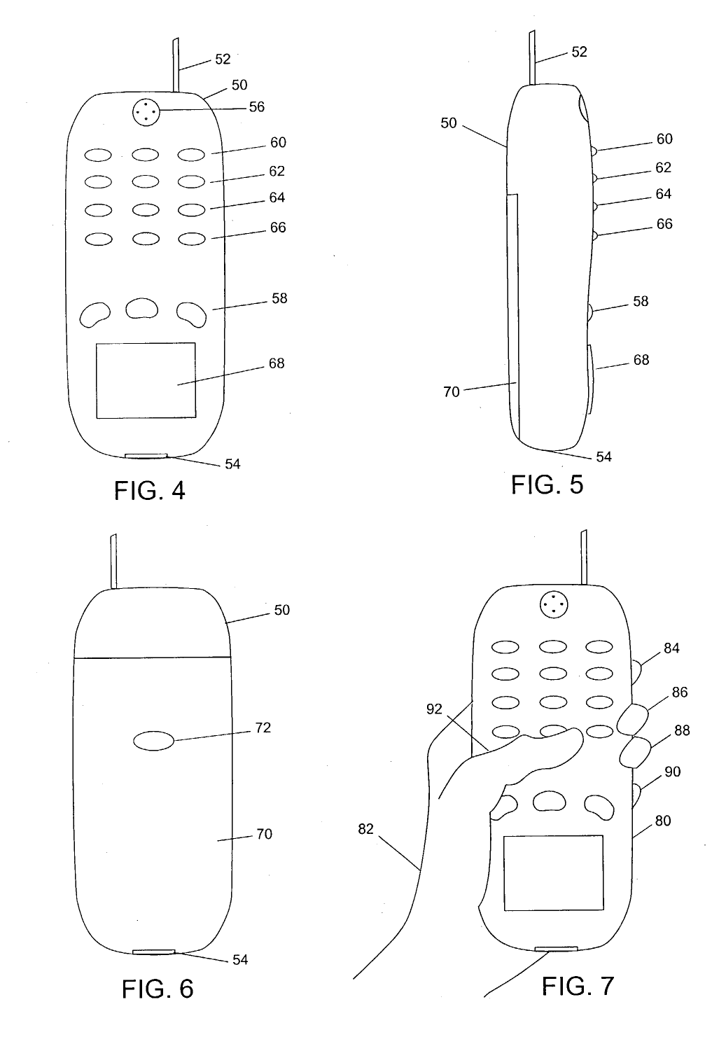

FIG. 5 is a side view of the cell phone of FIG. 4.

FIG. 6 is a back view of the cell phone of FIG. 4.

FIG. 7 is a front elevational view of a cell phone body resting in a palm of a hand with a person's fingers and thumb shown.

### DETAILED DESCRIPTION

As shown in FIGS. 1, 2, and 3, a standard cell phone comprises an outside casing 10 with the phone having an antenna 12, a microphone 14, a viewing screen 16, an earpiece 18, a row of command or scroll keys 20, and four rows of numerical keys 22, 24, 26, and 28, with row 28 also including the typical asterisk and pound keys.

As can be quickly recognized, the viewing screen 16 is above the rows of scroll and numerical keys 18. Prior art cell phones typically follow this general layout. Additionally, as depicted in FIGS. 2 and 3, the phone can include a back cover 30 housing a battery (not shown) and a back cover release button 32.

In contrast to the prior art telephone depicted in FIGS. 1-3, FIGS. 4-6 illustrate a telephone in accordance with the inventive arrangements. As shown, the telephone can include an outer casing 50, an antenna 52, a microphone 54, an earpiece 56, a row of operational or scroll keys 58 and four rows of numerical keys 60, 62, 64, and 66. Importantly, the viewing screen 68 is positioned below the numerical keys 60, 62, 64, and 66. Additionally, as shown in FIGS. 5 and 6, the telephone can include a back cover 70 that houses a batter (not shown). The back cover can be release by actuating the back cover release button 72.

With reference to FIG. 7, a cell phone body 80 is shown with a hand 82 conveniently gripping the phone. Fingers 84, 86, 88, 90 are shown with the positioning of the thumb 92 in a convenient rest position. The ergonomic placement of the numerical keys 60, 62, 64, and 66 and the viewing screen 68 can allow the thumb to easily engage the numerical keys 60, 62, 64, and 66 without covering the viewing screen 68. Additionally, with such an ergonomic organization, the numerical keys 60, 62, 64, and 66 can be comfortably engaged without moving the telephone in the user's hand. Thus, a user can operate the telephone with only the user's thumb and without a need to first orientate the phone in the user's hand.

The positioning of the operational row of keys in accordance with the inventive arrangements can either be above the numerical key rows (not shown) or at the bottom of the numerical keys immediately above the viewing screen, as shown in FIG. 4. In either arrangement, the operation row of keys can be comfortably actuated by the user's thumb without the need for strenuous bending of the thumb or for re-orientating the phone in the user's hand.

As can be appreciated from comparing FIGS. 4 and 7, organizing the phone with the viewing screen 68 at the bottom of the cell phone provides a screen that is continuously available for viewing, even when engaging the numerical keys 60, 62, 64, and 66. For instance, the knuckle of the thumb 92 as bent upward does not fall in front of the screen 68, as the screen 68 is below the thumb 92 at all times during operation of the phone. In sharp contrast and as illustrated in FIGS. 1 and 7, the bottom row 28 of the numerical keys can be hard to reach with thumb 92. Further, the thumb 92 can fall in front of viewing screen 16 and obscure a portion of the screen 16.

While the preferred embodiment of the invention is described herein and illustrated particularly in FIGS. 4-6, it is to be appreciated that the positioning of the elements relative to one and another can be utilized on a variety of wireless devices such as Palm Pilots™, Blackberries™, and any other wireless device requiring manipulation of fingers and viewing data on a screen. Additionally, the invention is not limited to wireless devices, as the positioning of elements can also be included in wired devices, such as traditional land line phones.

As appreciated from FIG. 7, such a wireless device can be conveniently held in one hand while the thumb can be used to operate and engage the buttons on the phone. Such ergonomic positioning of the buttons, conveniently position these operation elements in the proximity of the thumb, as the device is held comfortably by the hand.

This invention can be embodied in other forms without departing from the spirit or essential attributes thereof. Accordingly, reference should be made to the following claims, rather than to the foregoing specification, as indicating the scope of the invention.

I claim:

1. A wireless device for operation by one-hand, comprising:
operational elements including a viewing screen and a numeric keyboard, wherein the viewing screen is positioned below the numeric keyboard.

2. A wireless device having a keyboard and a viewing screen wherein said viewing screen is located below said keyboard.

3. A wireless device having all operational elements including a keyboard and a viewing screen comprising:
a viewing screen being positioned lower on said wireless device than said keyboard, with said keyboard being positioned above said viewing screen.
